(19) United States
(12) Patent Application Publication
(10) Pub. No.: US 2005/0280721 A1
(43) Pub. Date: Dec. 22, 2005

(54) Method for providing combined gain compensation and error correction of a camera pickup array and an apparatus for implementing the method

(76) Inventors: Auke van der Heide, Eindhoven (NL); Takashi Urano, Funabashi-shi (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/870,014

(22) Filed: Jun. 18, 2004

(51) Int. Cl. H04N 9/68

(52) U.S. Cl. 348/231.6; 348/234

(57) ABSTRACT

A method for providing combined gain compensation and error correction for a camera pickup array includes assigning and storing. The act of assigning assigns a memory location that accommodates for storing a representation of a multibit gain value to each relevant pixel in the array, assigns a first value range in the location to a range of feasible pixel gain values, and assigns at least one second value in the location to a faulty gain value. The act of storing includes storing pixel values for a multi-pixel image and reading out the multi-pixel image while compensating to a standardized image value for feasible gain values but accessing a correction algorithm for a faulty pixel gain value.

### BACKGROUND OF THE INVENTION

The invention relates to a method for effecting Gain Compensation and Defect Pixel Correction in camera systems. In present day's image sensors, such as for example, but not exclusively, used in digital hand held cameras, the number of pixels used effectively is great and still fast increasing. Due to imperfections in the manufacturing process, certain pixels will produce incorrect output values, such whilst still not exhibiting a stuck-at function. Generally, even the response of useful pixels is non-uniform over the image. For the latter pixels, the storing of a representation of a gain quantity or correction quantity would allow to effect a near-perfect correction. The finding of the gain is effected through well-known calibration procedures. Generally, the correction quantity is immediately related to the gain, such as being the inverse thereof. However, the inventor has recognized that such procedure would not represent a remedy for the problem caused by incorrect or defective pixels, and these defective pixels should therefore be indicated by a separate item in memory. Both the above problems can in principle be mended by executing a specific factory alignment operation. The Defect Pixel map is generated by analyzing at least an all-black image and also an all-white image, which procedure may be separate from the finding of the gain factor calibration.

Now, the Gain Table is taken without a lens in place to minimize the shading component of the lens. Using an 8-bit table for an 11 Megapixel device would then require at least an 11 Mbyte memory.

Pixels that have deviations from standard values within certain predetermined ranges can be categorized as being a good, small, medium, or large defect pixel. Using a 2-bit defect pixel indication will then require at least 2.8 Mbyte additional memory for the above device. Moreover, for representing each pixel, two memory accesses are necessary, which would tend to slow down and complicate overall operation. The defect could be qualified into more or other categories.

The present inventor has recognized that due to the specific character of the gain non-uniformity and due to the distribution of the various defects, the above two memories could be combined into a single one, practically without giving up on the image reconstruction quality of the overall device.

### SUMMARY TO THE INVENTION

In consequence, amongst other things, it is an object of the present invention to provide a method according to the above that uses only a single memory organization for indicating both the gain variations and the error character for a pixel array that may have a megapixel size.

Now therefore, according to one of its aspects, the invention features the various items recited in Claim 1 hereinafter. According to a particular advantageous approach, the combining of the actual gain factor of a particular pixel, and certain properties of the image that may be present on the scale of a plurality of further, surrounding pixels, allows to use both stored features for adjusting the respective pixel values to attain a still higher corrective capability of the device.

The invention also relates to an apparatus as recited in Claim 9; such apparatus could be a semiconductor chip or chip set, or another subsystem. The invention also relates to a camera featuring such apparatus as recited in Claim 10. Both the saving on memory size and the improving on algorithm quality would further enhance the usefulness of such generally small-size products.

### BRIEF DESCRIPTION OF THE DRAWING

These and further features, aspects and advantages of the invention will be discussed more in detail hereinafter with reference to the disclosure of preferred embodiments of the invention, and in particular with reference to the appended Figures that illustrate:

FIG. 1, an overall block diagram of an apparatus according to the invention;

FIG. 2, the set up of the various value ranges in memory;

FIG. 3, an exemplary flow diagram for implementing the inventive method.

### DETAILED DESCRIPTION OF PREFERRED EMBODIMENTS

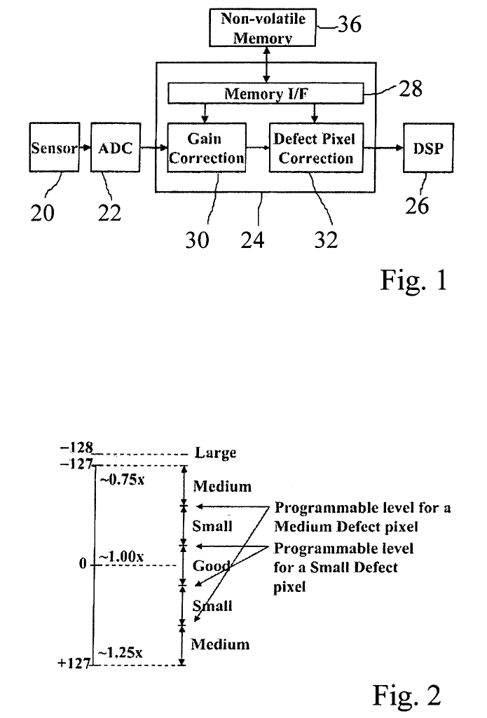

FIG. 1 illustrates an overall block diagram of an apparatus according to the invention. For simplicity and clarity, sensor and memory technology aspects of the apparatus have been generally omitted, inasmuch as persons skilled in the art would know to find enough information thereon. Now, item 20 represents the sensor, together with the associated optics, mounting, pixel accessing, and the like. The sensor may operate in one color, but usually a more-color approach is adopted. The present invention should be useful in both types of application. For three colors, a well-known arrangement is then the Bayer pattern where odd rows of pixels pick up alternating Red and Green pixels, whereas even rows pick up alternating Blue and Green pixels, the set of Green pixels then being arranged according to a checkerboard pattern. Other arrangements are feasible.

Block 22 represents the Analog-To-Digital conversion feature, wherein each analog pixel output signal is converted into a suitable bit width. Block 24 represents the combined gain compensation/error correcting feature of the apparatus, through gain correction facility 30, defect pixel correction facility 32, and Flash ROM interface facility 28. Item 36 represents the Flash ROM memory proper that contains the various pre-stored data items for the pixels from sensor 20. Other non-volatile memory technologies would be feasible. After gain correction and defect pixel correction, the pixel data are forwarded to Digital Signal Processor 26 for further processing, such as false coloring, gain extending/compressing, and various processes that fall outside the scope of the present invention. The output of DSP 26 can feed a display facility, hard copy, and various other user systems. For evaluating the actually necessary Gain Compensation values and Defect Pixel Locations, a similar set-up can be used, be it with a standardized image input, and if necessary, inverting the values for storing in memory 36.

FIG. 2 illustrates the set up of the various value ranges in memory. In particular, at left the value range of 8-bit signed values is shown, that goes from −128 to +127, and which value for each pixel has been stored in the 8-bit combined Gain/Defect Table. Associated to each bit value shown at left is a particular Gain factor that in the embodiment shown lies between 0.75 and 1.25 as shown, but which for clarity has only been shown for the bit values −127, 0 and +127. The intermediate range features appropriate Gain factors that follow a smooth scale. As the case may be, other value ranges would be appropriate. If required, these values would be programmable during generating the Defect Pixel Map, or even during later use, such as to compensate for aging of the sensor.

Far at right in the Figure, the classification of the defect pixels has been shown, which allows the algorithm to treat them differently. For instance, a small or medium defect in a low spatial frequency area of the picture can easily be corrected through using a simple interpolation algorithm in such a way that it is impossible to find the defect after correction. However, when a small or medium defect is located in a high spatial frequency region of the picture, simple interpolation will often be less successful. In fact, the interpolation could produce an error that would make the result look worse than the original. Often it is therefore better to not correct a small or medium defect in a high frequency area.

As shown, the qualification or errors is into good, small, or medium, and the various thresholds could be programmable as required. For large errors, only one single value “−128” has been selected for signaling a defective pixel. In fact, a pixel with a large defect could also have non-uniform properties, so that using the gain factor for correction would have uncertain merits. In fact, the actual gain factor could be dependent on the input light strength, it could have time-varying jitter, or it could be subject to various other malfunctions.

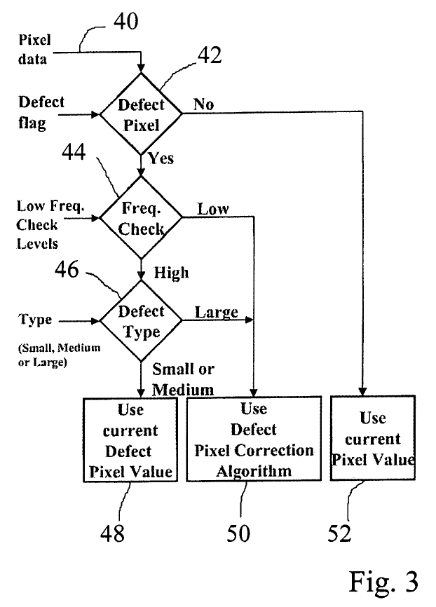

FIG. 3 illustrates an exemplary flow diagram for implementing the inventive method. For simplicity, setting up of the procedure has been omitted from the Figure. At the top, item 40 illustrates the sequential entry of the pixel data, both the sensed data, as well as the data stored in memory 36. In block 42, the system checks whether the defect flag (−128) is present. If no, the current pixel value is used, subject to adjusting by the gain value (block 52). If a defect flag is present however, in block 44 the system checks for the presence of only spatial low-frequency image components. If positive, the system goes to block 50 for using the defect pixel correction facility, such as through interpolating. If high-frequency components are present, no such correction/interpolation is effected. In that case, the gain correction can nevertheless still be made.

The checking for spatial high frequencies may proceed in various way. One manner is checking local variance of the actual pixel values as a percentage of average value. Another is checking for intensity steps or other distinguishing features in the picture. The checking can be executed separately for each color present. Existence of the above variance for one color could be sufficient for finding high variance. The checking may be done in various orientations separately. If found, the direction of the intensity edge could govern the interpolation solely in a direction along the intensity step.

The correction proper is not repeated herein for brevity. Instead, earlier applications assigned to the same assignee as the present application, U.S. Ser. No. 10/658,523 and U.S. Ser. No. 10/658,413, both filed on Sep. 10, 2003, describe the correction process and are incorporated herein by reference.

If negative in block 44 (i.e., there are relatively large spatial high frequency components) in block 46 the system tests whether the pixel in question has a large, medium or small defect type, as based on the data in FIG. 2. If the defect is large, the system goes to block 50 for effecting a defect pixel correction, as discussed hereabove. If the defect is small or medium however, in block 48 the current defect pixel value is used instead, and no correction is executed. Although not expressly shown, the output of all three blocks 48, 50, 52 is forwarded to DSP block 26 shown in FIG. 1. The various steps in FIG. 3 have been cited by way of example; various other approaches could be taken.

Now, the advantages of the invention as discussed can be summarized as follows:

a. The size of the memory necessary for storing the combined Gain/Defect Table is only determined by the size of the Gain Table. The Defect Table is inherently encoded into the Gain Table and does not require additional memory.

b. The combined Gain/Defect Table can be accessed in any feasible direction, such as normal, mirrored (such as left/right or up/down), rotated (such as interchange vertical and horizontal).

c. Defect pixels with various different defect sizes (such as small, medium, large) can be treated in different ways, which results in better performance, especially when correcting (or not correcting) small and medium defects in a region of the image which is spatially high-frequency.

Now, the present invention has hereabove been disclosed with reference to preferred embodiments thereof. Persons skilled in the art will recognize that numerous modifications and changes may be made thereto without exceeding the scope of the appended Claims. In consequence, the embodiments should be considered as being illustrative, and no restriction should be construed from those embodiments, other than as have been recited in the Claims.

1. A method for providing combined gain compensation and error correction for a camera pickup array, said method comprising:
assigning a memory location for storing a representation of a multibit gain value to each corresponding pixel in the array;
assigning a first value range in said memory location to a range of feasible pixel gain values;
assigning at least one second value in said memory location to a faulty pixel gain value;
storing pixel values for a multi-pixel image; and
reading out the pixel values of said multi-pixel image while compensating the pixel values within the first value range to a standardized image value and accessing a correction algorithm for pixel values equivalent to the faulty pixel gain value.

2. A method as claimed in claim 1, wherein said first value range is divided into partial ranges of respective feasibility levels and said correction algorithm is also accessed for a selected partial range of relatively lower feasibility within said first value range.

3. A method as claimed in claim 1, wherein said correction algorithm executes an actual correction for a particular pixel as being based both on surrounding pixel values and on the feasibility level.

4. A method as claimed in claim 2, wherein said correction algorithm executes an actual correction for a particular pixel as being based both on surrounding pixel values and on the feasibility level.

5. A method as claimed in claim 3, wherein said correction algorithm executes an actual correction for a relatively lower feasibility level, whereas for a relatively higher feasibility level said actual correction is foregone when detecting locally a high spatial frequency in said image.

6. A method as claimed in claim 4, wherein said correction algorithm executes an actual correction for a relatively lower feasibility level, whereas for a relatively higher feasibility level said actual correction is foregone when detecting locally a high spatial frequency in said image.

7-12. (canceled)

13. A method as claimed in claim 1, wherein said range of feasible pixel gain values contains respective partial ranges of small, medium and large defects, respectively.

14-38. (canceled)

39. An apparatus being arranged for implementing a method as claimed in claim 1 for providing combined gain compensation and error correction for a camera pickup array (20), said apparatus comprising:
means for assigning a memory location for storing a representation of a multibit gain value to each corresponding pixel in the array, assigning a first value range in said location to a range of feasible pixel gain values and assigning at least one second value in said location to a faulty pixel gain value;
means for storing pixel values for a multi-pixel image;
means for reading out the pixel values of said multi-pixel image while compensating the pixel values within the first value range to a standardized image value and accessing a correction algorithm for pixel values equivalent to the faulty pixel gain value.

40. A camera device featuring an apparatus as claimed in claim 39.

41. A method as claimed in any of claims 1 to 6, wherein foregoing an actual correction by said correction algorithm enables said compensating to a standardized image value.

42. A method as claimed in claim 1, wherein respective partial ranges of feasible pixel gain values enable various different approaches within said correction algorithm.

43. A method as claimed in claim 42, wherein said respective partial ranges of feasible pixel gain values have one or more programmable boundaries.
